(19) United States
(12) Patent Application Publication
(10) Pub. No.: US 2024/0421385 A1
(43) Pub. Date: Dec. 19, 2024

(54) DEVICE FOR PRODUCING DC CURRENT

(71) Applicant: HYPER ENERGY AUSTRALIA PTY LTD, Darlinghurst (AU)

(72) Inventor: Åge SKOMSVOLD, Tønsberg (NO)

(73) Assignee: Hyper Energy Australia Pty Ltd, Darlinghurst (AU)

(21) Appl. No.: 18/703,193

(22) PCT Filed: Nov. 1, 2022
(86) PCT No.: PCT/NO2022/050248

§ 371 Date: Apr. 19, 2024

(30) Foreign Application Priority Data
Nov. 2, 2021 (NO) 20211319

(51) Int. Cl. H01M 16/00; C25B 9/015; C25B 9/05; C25B 9/23; C25B 9/65; C25B 9/67; C25B 9/75; C25B 9/77; C25B 11/031; C25B 11/037; H01M 8/0258; H01M 8/04029; H01M 8/04119; H01M 8/242; H01M 8/2457; H01M 8/2483

(52) U.S. Cl. CPC H01M 16/003; C25B 9/015; C25B 9/05; C25B 9/23; C25B 9/65; C25B 9/67; C25B 9/75; C25B 9/77; C25B 11/031; C25B 11/037; H01M 8/0258; H01M 8/04029; H01M 8/04156; H01M 8/242; H01M 8/2457; H01M 8/2483

(57) ABSTRACT

The present disclosure provides a device for producing DC electricity and water with supplied hydrogen and oxygen, as well as where the device is arranged to be reversed to produce hydrogen and oxygen by supply of water and DC current.

### AREA OF INVENTION

The following invention relates to a device for producing electricity and water production from added hydrogen and oxygen, as the device can reverse the process of producing hydrogen and oxygen from water and electricity supplied to the device.

### TECHNICAL BACKGROUND

Current devices for producing electrical production from fuel cells include a bipolar cell stack with multiple cells or a cell pack that also contains the necessary insulation and all medium channels supplied with hydrogen and oxygen, which chemically and catalytically convert the gases into electricity and water vapor. Fuel cells are available for both low temperature (LT) and high temperature (HT) fuel cells. These cell stacks are currently static and operate at near atmospheric pressure, and this has its drawbacks.

When H₂ and O₂ come into contact with their respective catalytic electrodes in the cells, the reaction with a proton-conducting electrolyte (H₊), solid or liquid, produces water vapor on the anodes/electrodes of the oxygen side, or with an anionic conductive electrolyte (OH⁻) solid or liquid, the water vapor will be produced on the hydrogen side cathodes/electrodes. In both cases, electric current, water vapor, and more or less heat are produced depending on the cell voltage (V). The water vapor requires volume and reduces the contact of the gas with the electrode where the vapor is formed. This results in losses, reduced capacity and higher heat production instead of electric production.

Initially, it would be beneficial to increase the pressure so that the water produced, instead of steam, was formed as liquid water on the electrode, to provide more access for the gas. The problem is that today's static fuel cells operate in only 1 G gravity and thus too much of the produced water remains on the electrode, which in turn blocks the gas supply. According to Gibbs free energy, the fuel cell's theoretical efficiency will increase by 16.2% by forming liquid water instead of water vapor and allowing excess water to be removed continuously from the electrode's surface.

Today's fuel cells are difficult to combine with reversing the process, so the cells can also be used as water electrolysers by splitting the water into hydrogen and oxygen with supplied water and electric current (EL). The challenge with this combination is that a static electrolyser will require far more volume for the produced gases to avoid gas blocking losses on the electrodes and through the water. This, in turn, will make the fuel cells too large and uneconomical with a combined device for this.

On the other hand, today only SOC (Solid Oxide Cells) have somewhat better reversible possibilities, but they must operate at a very high temperature at low pressure and in the water vapor phase to work in both fuel cell and electrolyser modes, to which the combined ceramic-like membrane electrodes are adapted. The challenge today is the high temperature and that in the reaction there are point temperature increases that are difficult to dissipate at 1 G as in today's operation and relatively large apparatus. This results in degradation of the catalyst and the electrolytic thin membrane between the electrodes and gas leakage through the membrane which will result in more heat and cell breakdown. If SOC were adapted to higher pressures and G, it would provide higher convections in the cells and better distribute the heat, water vapor, gases and make SOC more compact which in turn improves the temperature balance in the cells and transport heat in/out to/from SOC and provide higher efficiency, greater flexibility and power density.

### SUMMARY OF THE INVENTION

The purpose of the present invention is to produce a compact device for electrical production with hydrogen and oxygen that has a higher efficiency than known static fuel cells and sets an improved standard for safety.

The device is a bipolar cell pack that is arranged rotatable. The device can be adapted to the pressure and temperature of low-temperature fuel cells, where liquid water can be formed on one of the respective electrodes in the cell pack, which during constant rotation will be continuously hurled outward towards the periphery and provide a significantly higher active area for the gas's contact at respective electrodes with adapted catalyst. The device can also be designed as a high-temperature fuel cell, where the produced water will be in water vapor phase. The rotation of the cell pack provides a high G and better convection in the cells. In both cases, performance, efficiency and power density increase and make the fuel cell stack significantly more compact and will improve the temperature balance in the cells. The rotation and high G mean that it is relatively easy to combine the fuel cells with a device and process to become a water electrolyser by reversing the process of supplying electricity and water that is converted into hydrogen and oxygen.

This is achieved with a device according to the attached description and patent claims.

### BRIEF DESCRIPTION OF THE DRAWINGS

The invention will now be described in detail with reference to attached figures, where additional characteristics and advantages of the invention are stated in the subsequent detailed description.

FIG. 1 presents a principled embodiment of the invention, in which an incision along the axis of rotation and one half of the rotational device is shown; the other half is a mirror image of the half structure that appears along one side of the longitudinal axis of rotation and shows a cell stack that juxtaposed forms a hollow cylindrical shape around the axis of rotation and in which principal details from a cell are highlighted.

FIG. 2 presents a principled embodiment of the invention, in which an incision along the axis of rotation and one half of the rotational device is shown, similar to that of FIG. 1; with two cell packets, channels, chambers in the rotor and static parts around the rotor with a gland-box and power connections in contact with the rotor are shown, with reference numbers from both FIG. 1 and FIG. 2.

### DETAILED DESCRIPTION OF THE INVENTION

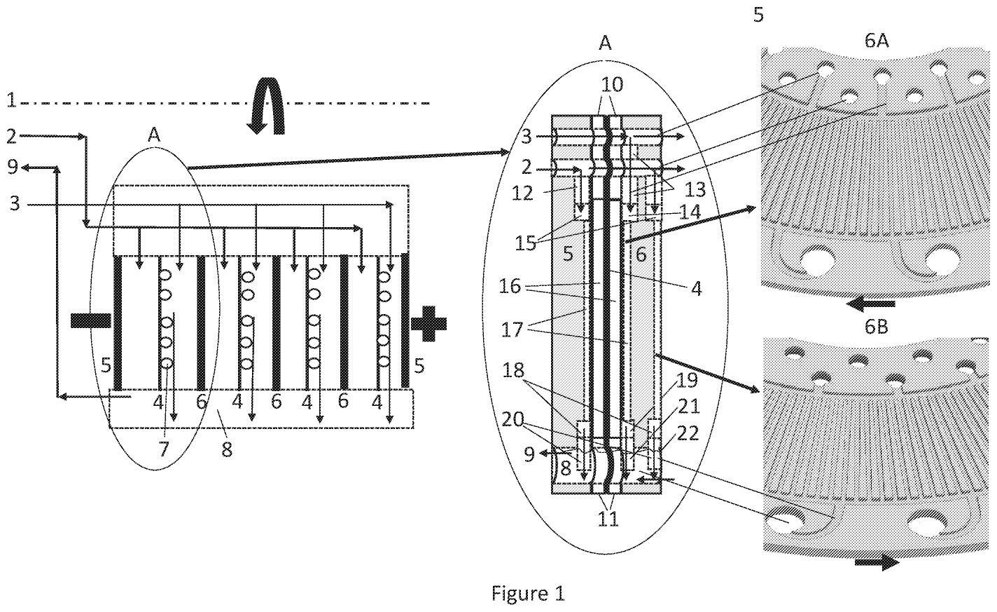

FIG. 1 and according to the brief description of the figure shows a longitudinal section of the device, where hydrogen channel 2 and oxygen channel 3 are supplied at the axis of rotation 1 from each of its dedicated channels, each branching radially outward into several channels 2, 3 and further into several axial collecting channels within the cells, from which channels direct hydrogen and oxygen to either side of the cells in a bipolar cell stack/cell pack, where all the parts in it are perpendicular to the axis of rotation 1 and have an inner and outer diameter that together form a hollow cylindrical cell pack centered and balanced around the axis of rotation 1. In the figure's example, it consists of five bipolar discs consisting of a positive (+) and a negative (−) bipolar end disc 5, with only one side facing the first and last cells of the cell stack, respectively. The other center bipolar discs 6 are both sides towards each cell, and which together form four cells between them, with a membrane disc 4 in each cell. There may be far more cells than shown. Membrane discs 4 are electrolytic and can be alkaline or acidic and adapted for either proton or anion conductive, with or without reinforcement and adapted for LT (polymer) or HT (ceramic). Each side of membrane disc 4 can be catalytically coated and it can be in contact with or attached to a supporting disc with El conductive material that is porous or of a woven material in contact with each bipolar disc 5, 6. Said porous discs form the electrodes (anode and cathode) on either side of the membrane disc 4. The cell stack in the figure is blown up to show detail, normally it is pressed together and then forms a hollow cylindrical shape, centered and balanced around the axis of rotation 1 with sealing and EL insulation along the inside and outside periphery of each cell. There are dedicated channels for gases 2, 3, and for water with multiple axial water collection channels 8 in the perimeter at the periphery branching inwards/outwards towards/from outlets/inlets water 9 from/to each side of the membrane disc 4 in each cell depending on whether the device is in fuel cell or water electrolyser mode, where all the complete cells with channels, sealing and insulation form a cell pack.

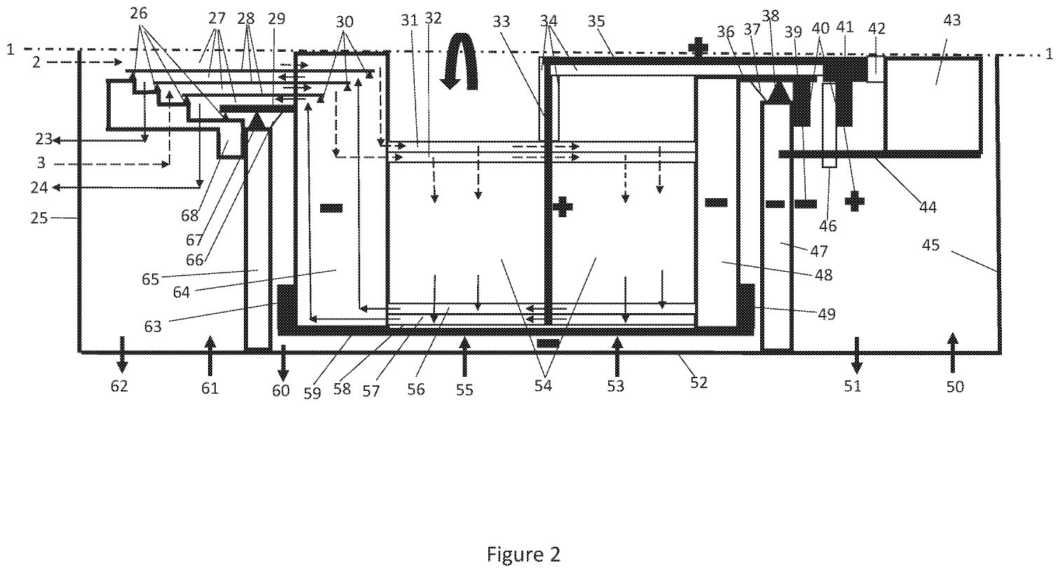

When starting up to LT fuel cell mode, the cells can initially be filled with water that start-moistens the membrane 4, which during constant rotation and when hydrogen from its channels 2 and oxygen from its channels 3 are pressed with equal and adapted pressure via each gland-box (shown in FIG. 2) to either side of the membrane disc 4 in each cell, the water will be pressed outward to several axial water collection channels 8 outside the periphery of the cell pack, and not in contact with the electrodes 5, 6. The excess water is diverted from the periphery of the water collection channels 8 connected to dedicated outlet/inlet water 9 channels from the device at the axis of rotation 1. When the water is driven out of the cells and the fuel cell switches to normal operation with EL production via the cells, water droplets 7 are formed on one of the electrodes' sides in the cells towards the membrane 4, which are immediately centrifuged or hurled outwards towards the periphery of the water collection channels 8 as the water is formed by the reaction and some of the water draws into the membrane disc 4 and excess water is centrifuged away from the membrane disc 4 and the electrode and ejected outwards to the water collection chamber 8.

By adapted rotation and pressure of gases 2,3 into the cells, water collection channels 8 at LT will also act as a water trap with a constant surface radius as water is produced from the cells. This excess water is discharged at the outlet/inlet water 9 from the rotating device at the axis of rotation 1 via an adapted gland-box 68 (shown in FIG. 2).

Simultaneously with the gas supply, the cell stack will produce DC current, where +/− is led to separate slip ring at each end at the axis of rotation (shown in FIG. 2). The +/− slip rings are in contact with their respective static brushes to direct the current on (not shown) to a joined circuit. The cell voltage (V) from a bipolar cell stack, the cell voltage in each cell is added together. The current (A) is equal in all cells throughout the cell stack and regardless of the number of cells. This is also similar in electrolyser mode when powered DC voltage and current.

In LT and with reversing the process so that the same cell stack becomes a water electrolyser, the procedure is as follows: During rotation, the pressure of gases 2.3 at outlet is reduced, so that water from inlet 9 via the water collection channels 8 fills the cells via radial channels on each side of membrane disc 4 from the water collection channels 8. Then the DC is applied via their respective +/− brushes, +/− bipolar end discs 5 with custom voltage (V) that simultaneously provide a current (A). At the same time, where hydrogen and oxygen were previously supplied in the fuel cell from their channels 2.3 in the cells, at the correct direction of flow (A) the same gas will be produced in the same place in the cells by splitting the water 9 that is continuously supplied. The high G will provide great buoyancy force on the hydrogen and oxygen gas bubbles that form on membrane disc 4 and its electrodes 5, 6 where the gas bubbles detach rapidly and propel them rapidly through the water inward toward the center and out into their gas channels 2, 3. With a custom/regulated pressure out, a hollow cylindrical water table within the inner radius of the electrodes forms and only gas outputs into their channels 2, 3. The pressure out is equal to the centrifugal force of the radius of the water column from inlet 9 to the radius of the water table. The higher the rpm, the higher the gas pressure can be regulated out, while the device can suck the water 9 in, or increase the gas pressure out, by increasing the water pressure in 9. At the same time, the cell pack will act as a gas separator, which in today's water electrolysis plants are large tanks outside the electrolyser, which with the device can be omitted. Thus, the device sets an improved standard to safety. As the device is ultra-compact with very high power density, there is very little volume of the explosive gases until continuous detection of them just outside the rotor. If there is more than 4% of one gas in the other, it entails immediate shutdown and dumping of the production gases.

Highlighting A in FIG. 1, shows the mass flow direction in fuel cell mode at LT and in principle how a complete assembly of a cell pack can be, both for LT and HT.

The cell packets include bipolar end discs 5 and center bipolar discs 6, and in FIG. 1, both sides of the center bipolar disc 6 are shown as 6A and 6B, respectively, with rotation direction as arrow at periphery. Where the surface of bipolar end disc 5 towards the cell is equal to 6B and on the surface of bipolar end disc 5 on the second cell pack end towards the cell is equal to 6A in a series forming a bipolar cell pack of channels. All parts of the cell pack have in the area between the inner and outer periphery similar holes that, when assembled, form axial gas collection channels 2, 3 at the inner periphery and axial water collection channels 8 at the outer periphery. At the inner and outer periphery, combined sealing EL respective inner and outer insulation discs 10, 11 are laid out against each side of the bipolar discs 5, 6 The inner insulation discs 10 have the same internal radius as the bipolar discs 5, 6 and beyond to the equal radius of the inner circular hydrogen distribution channel 15 and on the cell's other side to the inner radius of the inner circular oxygen distribution channel 14. The outer insulation discs 11, have equal outer radius as the bipolar discs 5, 6 and inward to the outer radius of the outer circular distribution channel 18 for hydrogen-water and on the other side in the cell to the periphery of the outer circular distribution channel 19 for oxygen-water. The gases are directed from their axial collection channels 2, 3 via their respective radial cell gas channel for hydrogen 12 and cell gas channel for oxygen 13, which are led into their circular channels 14, 15 on either side of the cell. Cell water channel 20 for hydrogen-water and cell water channel 21 for oxygen-water runs radially between the cell and water collection channel 8 for the water and further in channels out/in 9, where each cell water channels 20, 21 runs from outer circular distribution channel 18, 19 in a backward-bent direction relative to the direction of rotation shown by arrow at the periphery of 6A and 6B, and each cell water channels 20,21 enters at the periphery of water collection channel 8 and forms a water trap that restricts a gas from coming over to the other side's gas. For example, at 1000 G in the cell water channel 20 and at 5 mm to the water surface 22 at the bottom of water collection channel 8, it corresponds to approx. 5 meters of water column at 1 G, or approx. 0.5 bar balance pressure. Between outer circular distribution channels 18, 19 and inner distribution channels 14, 15 on each bipolar disc 5, 6 there may be radial grooves forming shovels 17 between them as shown in 6A, B, and/or with porous electrically conductive material at the surface, which can also be catalytic. The rest of the bipolar end discs 5 towards the outer side at the ends and in the center bipolar discs 6 are gas tight and electrically conductive. Membrane disc 4 can have the same outer and inner diameter as the bipolar discs 5, 6, but no less diameter than the distance between inner insulation discs 10 and outer insulation discs between which membrane disc 4 must be pressed or fixed to both seal and hold in place. Membrane disc 4 will only be activated/catalyzed in the radius area between the outer periphery of the inner insulation discs 10 to the inner periphery of the outer insulation discs 11, so that membrane is not activated in area where it is laid out between the two outer—11 and the two inner—insulation discs 10. On each side of membrane disc 4 in activated area are porous electrically conductive electrode disc 16 in contact or attached with EL conductive and porous means to membrane disc 4. Electrode disc 16 is further supported between the outer periphery of each of its inner insulation disc 10 and the inner periphery of the outer insulation disc 11 and assembled in contact with their respective bipolar discs 5,6 in this radial area. Electrode discs 16 are as thick as their respective inner-and outer-insulation discs 10, 11 to come into contact with their respective bipolar discs 5,6 to both seal and provide EL insulation.

FIG. 1 shows common water collection channels 8 to the anode and cathode sides of the cell pack. There may also be common water collection channels to the anode side only and an equal number only to the cathode sides of the cell stack with each water channel being to outlet/inlet 9 (shown in FIG. 2) either at the same or separate shaft ends.

The membrane disc 4 has so far been explained by the fact that it can have catalytic coating with porous electrode discs 16 attached to either side that form the electrodes (anode, cathode). But the membrane can also be completely clean without catalyst and without porous electrode discs 16 (not shown). Instead, the bipolar discs 5, 6 can also act as electrode disc 16 and can be designated as bipolar discs 5, 6 with electrode discs 16, with a porous surface towards the cell that may be similar to that shown for sides 6A, 6B, but so that the shovels 17 are axially further inward towards the cell in contact with the membrane disc 4 and can advantageously also be axially backward bent in the direction of rotation (not shown), both to make room for insulation discs 10, 11, but also for the shovels 17 to replace some of the space the previously porous electrode discs 16 had. The current combined bipolar discs 5, 6 with electrode discs 16 must be gas-tight and electrically conductive towards the cell-ends and between each cell in the cell packet. Bipolar electrodes 5, 6 can be of gas-tight carbon, nickel, acid-resistant steel, titanium or composite, ceramic or other resistant electrically conductive material that may simultaneously have catalytic properties or coated/doped with beneficial catalyst in active area on the side facing the cell, adapted for LT or HT. When assembling, a good contact surface is formed between bipolar electrodes 5, 6, with electrode disc 16 and membrane disc 4 on each side of each cell. At the same time, the solution provides good support for the membrane discs 4 in high G during rotation, as well as providing space for far more cells of the same length compared to static solution. This will increase capacity, or provide better efficiency at equal capacity compared to statice devices, as the device's reduced volume provides reduced ohmic resistance, even with inferior catalyst than platinum commonly used today at LT or combined with Ni(O) YTZ or other membrane catalyst methods by HT.

The electrodes and membrane can also be coated with catalyst that can be in any form or in combination of: platinum, iridium, nickel, cobalt, iron, yttrium, zirconium, strontium, lanthanum, manganese or oxidized materials where similar properties with catalysts and catalyst alloys are known. On the oxygen side of bipolar discs 56 with electrodes 16, both they and membrane disc 4 have great need to be coated with catalyst. Similarly on the hydrogen side, but in smaller quantities as the reaction is relatively light compared to the oxygen side. The water that is formed will also settle as a thin film on the electrode, soak into the membrane and can act as electrolyte with the short distance in the cell. The porous surface of the bipolar electrodes can be coated with a catalyst towards the active cell surface, which is further be coated with a thin solid electrolytic membrane film on the surface of them, where they may be in contact with a main membrane disc 4 between anode and cathode side, or without such a main membrane and membrane from each electrode being in direct contact with each other or that the other bipolar electrode is contact with membrane applied to one of the cell's bipolar disc-electrode, or attached together during assembly with a custom porous and EL conductive porous paste. This makes it easier for the anion or proton to be conducted from the porous surface and further through membrane from a relatively larger active area. Hydrogen/oxygen will also be more easily converted to EL and water with greater access to protons or anions respectively and electrons via the outer circuit.

So far, the cell pack is explained by the fact that it is supported by bipolar discs 5, 6 which have an outer and inner diameter equal to the cell pack. But the bipolar discs may have smaller inner and outer diameters, and instead are supported there by electrically insulating and sealing discs that replace the space where the bipolar discs were previously (not shown). From just outside the periphery of the outermost gas hydrogen channel 2 at the inner periphery, in addition to sealing and inner insulation disc 10 between the bipolar discs. At periphery it is the same, where outer insulation disc 11 is in the radius from just inside the water collection channel 8 and all the way out to the outer periphery, similar as shown for bipolar discs 5, 6 in the same area with the same sealing/insulation between them as before. The radial cell gas channels 12, 13 and cell water channels 20, 21 can also be arranged in the new insulator discs as shown for 6A and 6B. Otherwise, the cell pack may be similar to shown and described in Highlight A, FIG. 1.

In bipolar solution with porous electrode discs 16 and catalyst on diaphragm 4, the inner and outer insulating discs 10, 11 are as thick as the bipolar disc and electrode disc 16 combined on the bipolar end discs 5 outside the outer and inner periphery of them and reduced by half the axial thickness of the center bipolar disc 6 outside the outer and inner periphery of those between the bipolar end discs 5. Thus, both the cells and the insulation gaskets come into contact with each other when the cell pack is assembled, and the insulation discs will both seal and provide electrical insulation radially inside and outside the cell pack so that EL current (A) can only pass through the cell pack via its bipolar end discs 5 +/−. In the last solution, electrode discs 16 have a slightly smaller diameter than the bipolar disc and membrane. The membrane can now have the same diameter as the bipolar discs 5, 6. Thus, the inner and outer insulator discs 10, 11 can be inset into the periphery of the electrode disc 16, where only membrane disc 4 has the same diameter as the bipolar disc and is clamped together and clogged by mounting equally combined sealing discs and inner and outer insulation discs 10, 11 on the other side of membrane disc 4 that is very thin and is sealed between the two insulating discs 10, 11.

The inner insulation discs 10 can also be constructed with several holes radially within and/or between or outside (not shown) the displayed gas channels 2, 3, where these holes are assembled form axial cooling channels connected via dedicated channels to one inlet gland-box and another for outlet (not shown) by the shaft. In water electrolysis mode, this provides good cooling to the gases that dry easily at high pressure. The condensed water from gases 2, 3 is quickly returned to the cells from the gas channels (not shown) in high G. Cooled oxygen will become dryer the higher the pressure, it also reduces oxidation against the materials out of the oxygen channel 3 and the pressure out can be increased without noble materials having to be coated inside its channels out of the rotor and beyond. In water electrolysis mode with said water cooling channels in the center, some of the water can be discharged and the rest directed to respective water collection channels 8 at periphery via water trap at periphery (not shown) similar to that of displayed cell water channels 20, 21 to periphery of water collection channel 8.

There may also be a hollow cylinder of EL insulating and sealing material along the entire outer and inner periphery of the cell pack when the bipolar discs are not insulated towards the outer side of the inner and outer periphery of the cell pack with the insulating discs 10, 11.

FIG. 2 shows, in principle, a longitudinal cross-section along the axis of rotation 1, where the device is shown on one side of this, with reference numbers to both FIGS. 1 and 2. The device is shown for both LT and HT for fuel cell mode with dotted arrow directions for gas and whole arrows for water/steam. The arrows will have the opposite direction when the device is reversed to electrolyser mode.

The rotation device is shown with a plus (+) +bipolar disc 33 in the middle which in the cell pack area may be designed similar to bipolar disc sides 6A and 6B, but with a whole disk at the axis of rotation 1 and with a cell pack 54 on each side, where a cell pack 54 is shown and described in FIG. 1 and where the cell packets 54 are oppositely positioned on either side of + bipolar disk to conduct EL current through cell packets 54 to/from ground potentials (−) on the other end of cell packets 54 that are in contact with ground potential. Cell packets 54 contain several axial hydrogen and oxygen collection channels 31, 32 to the cells in fuel cell mode and from the cells in electrolyser mode. There are also on the periphery several axial common water/steam collection channels to/from hydrogen sides 56 of cell packets 54 and several axial common water/steam collection channels to/from oxygen sides 57 in radius outside, but tangentially between water collection channel 56 of cell packets 54. The gas collection channels 2, 3 in their position at the inner periphery may be similar to those shown for gas channels 2, 3 in bipolar disk sides 6A and 6B and the same for water collection channels 56, 57 may each be similar as shown for water collection channel 8. Otherwise, the cell packets with channels may be similar to those shown and described earlier in FIG. 1. Outside the periphery of cell packets 54, they are enclosed by an EL insulating and sealing hollow cylinder 58, which is further enclosed, supported and centered around axis of rotation 1 with a hollow support cylinder 59 which can be of electrically conductive metal as shown and is at minus/ground potential, or it is of a composite material that can also be electrically conductive or insulating with extra minus brush (not shown) against shaft pipe duct 29 in contact with end cap fluid side 64. Furthermore, the support cylinder 59 is supported on opposite ends inside with separate end cap 48 and end cap fluid side 64 on EL side and they are made of electrically conductive material and in contact with support cylinder 59 and bipolar end disc 5 on each cell packets 54 minus/ground potential. End caps 48, 64 are held in place and perpendicular at the end of support cylinder 59 with each locking nut 49, 63 with outer threads fitting into corresponding internal threads on the inner side of the support cylinder 59 axially outside each end cap 48, 64. At the inner periphery of cell packets 54 with hydrogen and oxygen collection channels 31, 32, there may be both an insulating and/or a hollow metal cylinder or insulating composite supporting inward (not shown) at high pressure in cell packets 54. In LT, the end caps may have O-rings on the periphery for additional sealing or similar heat-resistant sealing at HT. Said EL insulating and sealing hollow cylinder 58 can also be adapted for sealing when the end caps are pressed onto it. It will also be sealed with the sealing discs when the cell packets 54 are compressed together in the rotational device and locked with the locking nuts 49, 63 against the end caps 48, 64 in a custom pressure. Each axial collection channels 31, 32, 56, 57 are located in different diameters as shown. On end cap fluid side 64 towards the collection channels, an O-ring may be laid out for each diameter between the channels, within the innermost channel and outside the outermost channel (not shown), to provide sealing to each collection channel towards the end cap fluid side 64. Between the O-rings there are circular grooves (not shown) that fit with the diameter of each collection channel 2, 3, 23, 24 for transporting fluid to outlet or from inlet via gland-box 68 at the axis of rotation 1.

End cap fluid side 64 with fluid channels to/from cell packets 54, can also be arranged with circular grooves (not shown) for insertion of sealing discs in the same radius as cell packets' 54 outer and inner insulation discs 10, 11 in FIG. 1, with equal holes in the end cap fluid side 64 for transport in channels 2, 3, 23, 24 of fluid to outlet or from inlet via gland-box 68 at the axis of rotation 1. Inner collection channels 31, 32 can have equal diameter (not shown) and every other hole is for one gas and between it for the other gas. Similar can be made for water/steam collection channels 56, 57 at the outer periphery (not shown) when tightened and insulating disc is used as mentioned in end cap fluid side 64 with equal holes and diameters for each fluid equal to the axial channels from cell packets 54 (not shown).

Bipolar end disc 5 and/or outer and inner insulation 10, 11 in contact with the second end cap 48 do not have holes for fluid collection channels 31, 32, 56, 57.

End caps 48, 64 are in the center attached to each centered hollow shaft at fluid and EL side 29, 36 which protrudes axially in adapted length where bearings EL side 38 and bearing fluid side 67 are placed outside dynamic sealing at EL and fluid side 37, 66 which is the innermost axially of each shaft at EL and fluid side 29, 36. Bearing can be ball bearings that are further supported in separate stator discs 47, 65 on each end. The stator discs 47, 65 have a slightly larger diameter than the support cylinder 59 of the rotor and the stator discs 47, 65 fastened at the periphery perpendicular to their shaft at fluid and EL side 29, 36 with an insulating protective stator tube 52 that encloses the stator discs and protects the entire device with gland-box 68, +/− brushes 40 and EL motor 43. The protective stator tube 52 has on each end its stator end cap fluid and EL side 25, 45, which seals and insulates. Stator end cap EL side 45 has bushings for electrical wiring (not shown) to the device EL motor 43 for rotation and a wire for each its +/− brushes 40. On the other end of the stator end cap 25 for fluid side, bushings of fluid pipes for connection to the device's fluid channels 2, 3, 23, 24 are connected via the gland-box 68's throughput channels for fluid out/in from/to the device's shaft pipe channels 27. The outer side of the fluid pipes seals the passage in the stator end cap 25. The protective stator tube 52 can be transparent and of acrylic tubes by LT or insulating temperature resistant material at HT.

On the end of the electric shaft at EL side 36 outside bearing EL side 38, an electrically conductive sleeve is pressed and centered, which is a slip-ring ground 39 and which is in contact with shaft at EL side 36 and radially outside in contact with +/− brushes 40 on the ground potential (minus) of a brush housing attached to the outer side of its stator disc 47. + brushes 40 are attached via their brush housing to an EL insulating brush washer 46 where + brushes are in contact with +slipring 41 attached to electrically conductive +bolt 35 which is attached to +bipolar disc 33 in center. Plus side is electrically insulated 34 inside rotor radially within cell packets 54, through end cap 48, shafts at EL side 36, EL insulating brush washer 46 and between El motor insulator 42 and EL motor 43. EL motor 43 and EL insulating brush washer 46 are attached to stator disc 47 with multiple bolts and distance sleeves 44 on bolts (not shown) for proper spacing and centering of EL insulating brush washer 46 and EL motor 43. The +/− brushes 40 connect to their respective +/− wire (not shown) for the EL DC to/from the cell pack depending on the operating mode as mentioned. When the cell packets 54 are pressed together, it simultaneously locks +bolt 35, allowing it to be attached to EL motor 43 for rotation of the rotation device suspended between bearing fluid side 67 and bearing EL side 38. Insulation 34 around +bolt 35, is adapted with means to simultaneously seal around it, between insulation and end cap 48 and inside shaft at EL side 36. EL wire to EL motor 43 to provide rotation to the rotary device is not shown. Pure air is supplied to air inlet EL side 50 and air inlet fluid side 61 with a fan through the protective stator tube 52 to the room within air inlet EL side 50 and for air inlet fluid side 61 and through respective air outlets EL side 51 and air outlets fluid side 62 in pipes to outside of the building. The air from each side is continuously measured to detect any hydrogen content above given values, in which case the device is automatically shut down (not shown).

On the fluid side, the shaft pipe duct 29 is hollow, with several inserted fluid pipes 28 of smaller diameter within each other, which on one ends outer side seals and fasteners 30 at different axial length inside the end cap fluid side 64, so that the thinnest inner pipe is furthest inside the end cap fluid side 64 and the thickest pipe is attached with seals and fasteners 30 axially furthest closest to shaft pipe duct 29 inside end cap fluid side 64 as shown. The other fluid pipes 28 are attached axially between the smallest and largest fluid pipe 28 as shown in FIG. 2. With an adapted cross-sectional area of the innermost fluid pipe 28, the shaft pipe channels 27 form between fluid pipe 28 and the largest pipe and shaft pipe duct 29, which transport in their respective fluid hydrogen channels 2, oxygen channels 3 and water/vapor 23, 24 to/from the ends of the cell stack via dedicated channels in the end caps shown by dotted arrows for the gases 2, 3 and whole arrows for water/steam 23, 24, channels branching inside the end cap fluid side 64 over to several radial channels from each shaft pipe channel 27 in the center at the end seals and fasteners 30 of each fluid pipe 28 and hollow shaft pipe duct 29 (as shown). Thus, each branching is radially outward at a different axial distance, where the smallest is axial at the center of the end cap fluid side 64 and further towards the thickest pipe at the end cap fluid side 64 before shaft pipe duct 29 with its shaft pipe channel 27 and radial branching from it. The radial channels for each shaft pipe channel 27 are outward in contact with their respective channels at the end of cell packets' 54 axial collection channels 31, 32, 56, 57, as at the outer periphery (water/vapor) 56, 57 and inner periphery (hydrogen and oxygen) 31, 32.

The static gland-box 68 for fluid in/out in its channels 2, 3, 23, 24, is attached with means attached and centered to the stator disc fluid side 65, where dynamic seals 26 are attached inside the gland-box 68, which seal at the ends of the rotating fluid pipes 28 and thus form tight fluid channels to/from static gland-box 68's inlet/outlet channels that are externally mounted and sealed with static pipes for transporting each fluid to/from each of its rotating shaft pipe channels 27.

The positive +bipolar disc 33 is electrically isolated against ground potentials inside the rotor outside cell packets 54 also inside the holes for fluid collection channels 31, 32, 56, 57 for fluid to/from both cell packets 54. +bipolar disc 33 is therefore only in electrical contact with its end to the bipolar cell packets 54 on either side of +bipolar disc 33. The ground potential (−) brush 40 is in direct contact with slip-ring ground 39 on shaft at EL side 36 which is in contact with end cap 48, electrically conductive support cylinder 59 and end cap fluid side 64 on the other end. This provides an insulated joined circuit between plus and minus brushes via cell packets 54. The whole device is externally on ground potential and in addition EL insulated externally with protective stator tube 52 and protection stator end cap fluid and EL side 25, 45. This will reduce the potential of creep-current from the device during operation to a minimum and therefore sets a new standard for safety.

At the water electrolysis mode and cell voltage below 1.48V and towards the reversible point of 1.23V, more heat must be supplied the more the cell voltage approaches the reversible point. Above 1.48V, more heat is produced that must be dissipated by cooling over the periphery. In fuel cell mode, it is beneficial to have a high temperature to get as close to 1.23V as possible, where the cell is in heat balance and in chemical/electrical 100% efficiency, but with low current (A) increasing at lower voltage (V). At fuel cell mode, heat production will increase at lower cell voltage and correspondingly reduce electricity production compared to the chemical energy in hydrogen. These variables normally present challenges in that the last cells in a long cell pack require a large flow to avoid a large change in temperature to the last cells in the channel. This is avoided by heating in/out over periphery with the nozzles for temperature control 53, 55 which gives approximately equal temperature throughout the water/steam collection channels 56, 57 even at very low flow rate, as well as also balancing the temperature radially inwards to all cells in both cell packets 54 throughout their length.

It is advantageous if the device is fixed vertically against a wall and/or floor, with a fluid-/gland-box 68 side down, and supplied cooling or heating fluid via several nozzles for temperature control 53, 55 through the protective stator tube 52 and which is led in contact with the entire periphery by the support cylinder 59 to the rotor. The fluid is then discharged through the protective stator tube 52 down at stator disc fluid side 65, where one or more drainage 60 pipes are placed for further transport and possibly collection and further utilization of the fluid. In the periphery, stator discs 47, 65 have seals that seal against the inner side of the protective stator tube 52, which on the outer side has a tightening band (not shown) outside each stator disc that locks the stator discs into position. On each tightening band, brackets with at least two rubber suspensions resembling engine mounts can be attached, which are further fixed against the wall (not shown).

As the displayed device may contain several hundred bipolar cells where there may be several cells per millimeter, it can provide very high EL voltage (V) which can be reduced to the half and double current (A) with one cell stack on each side of the +bipolar disk as shown. The rotor can then be relatively long with a small diameter, which gives the highest G at equal periphery speed, which is beneficial. When cooling or heating is used over the periphery, this channel length is of less importance for temperature change to the last cell in the channel. Distance is relatively short from the periphery of support cylinder 59 to the cells in rotor and smaller diameter rotor allows for shorter distance and improves temperature balance faster in cells. At HT and high pressure in fuel cell mode and lower voltage producing heat, cooling over the periphery can allow condensation of water vapor in water collection channels 56, 57 when refrigerant is supplied against periphery with nozzles for temperature control 53, 55 in adapted quantity that simultaneously stabilizes temperature inside the cell packets 54.

The gland-box 68 can be composed of several gland-boxes attached together and to the stator disc fluid side 65. They can be Zimmer-rings or cartridge seal type, adapted for high pressure and temperature, be oxygen resistant and can be silicon carbide type. The gland box can also be adapted with means for cooling, lubrication and pressure balance.

Bearing fluid side 67 and bearing EL side 38 can be ball bearings with means for lubrication, when there is sealing between gland-box 68 and stator disc fluid side 65 and there can be an additional Zimmer-ring dynamic sealing fluid side 66 or adapting the cartridge sealing is on either side of the bearing.

The bearings can also be plain bearings adapted to different fluids, temperatures and rotational speeds. When the device is mounted vertically and the gland-box 68 is down, bearing fluid side 67 must provide both radial and axial support in both directions between the weight of the rotor and the pressure/area in gland-box 68 to avoid the rotor being lifted up. Radial and axial support must also be provided if the device is placed horizontally.

In the space within cell packets 54 on either side of +bipolar disk 33, each room can be arranged as a separator to remove the gas from the water by LT water electrolysis (not shown). For example, in the space towards the end cap fluid side 64, oxygen and water come to this space from its side in all the cells via the collection channels 32. There are several openings radially inward from these channels into the separator compartment just after the + bipolar disc on this side. The oxygen is discharged dry to its shaft pipe channel 3, 27 with several holes in the circle into the oxygen shaft pipe channel 3, 27. The radius of the water level becomes radially outside the hole/channels to the oxygen shaft pipe channel 3, 27 and forms a hollow water cylinder with the gas in the center. The radius of the water level is regulated by the pressure out towards the rpm and the pressure of the water in. In the center room towards the EL end cap 48, the same can be arranged for hydrogen and water from the cells, which are separated from the water there. The hydrogen is directed through isolated channels at the center in the +bipolar disc 33 and over to an insulated and tight collection cup attached to the insulator on the other side of the +bipolar disc, where the oxygen separator is the compartment outside. At the center of the hydrogen collection cup, a pipe is fastened and sealed through a hole in the center of the end cap fluid side 64, where there is sealing and fastening to the hydrogen tube, which can be an extended fluid pipe 28 from gland-box 68's hydrogen channel 2 into the hydrogen collection cup. The gas separators will be proportionally more compact against static 1 G separators compared to G inside the hollow water cylinder in the separator. E.g. 100 G provides 1/100 smaller separator in rotor with the same capacity as with 1 G. Thus, the amount of hot water or electrolyte can be reduced accordingly and set a new and improved standard of safety in addition to reduced space and cost.

Also, the rotation device can contain only one cell pack 54. Where then +bipolar disc 33 is moved all the way towards end cap 48 with an El isolating and sealing disk between them. In this case, holes through the +bipolar disk are not required for fluid collection channels 31, 32, 56, 57, and only side towards the nearest cell from the +electrode can resemble the side 6A and the other side towards the insulating disk is level.

EL insulation 34 materials for inner and outer insulation discs 10, 11, +bipolar disc 33 with +bolt 35, +brush EL insulating brush washer 46, shaft for EL motor insulator 42, EL insulating and sealing hollow cylinder 58 and other electric insulations as mentioned can be Teflon, PEEK, ceramic, glass, mica, composite or equivalent or EL insulated metal for better support. They must also be oxidation-resistant and adapted for LT or HT respectively.

For said cooling or heating over the periphery via nozzles for temperature control 53, 55, it can be with cold or hot water/steam against the periphery of the rotating support cylinder 59 on ground potential, respectively. In the case of cold water via nozzles for temperature control 53, 55 towards the periphery, heat is extracted from the cell packets 54. The water is continuously drained out through said drainage 60 via pipes for possible reuse or distillation of the heated water at a negative pressure or that the water evaporates on the support cylinder 59. The distilled water and produced water from the fuel cell can be used in the device by electrolyser mode. At least one of the nozzles for temperature control 53, 55 can also be directed more tangentially with the direction of rotation to provide custom rotation to the rotary device that has custom vanes for this on the outer side of the support cylinder. Thus, the EL motor can be omitted.

The device can function as a battery (not shown), in that pipes from/to the gland-box 68 lead to/from storage tanks for oxygen, hydrogen and two water tanks where one is from/to anode and the other from/to cathode sides in the rotation device, where the water is directed to its respective tanks during water production in fuel cell mode and regulated back to its respective anodes, cathodes side in water-electrolyser mode. In water electrolysis, hydrogen from the cells is led through the gland-box to a combined deoxidizer and dryer, which removes oxygen residues below 4% and dries and cools the gas before it is led or can be pressurized via a compressor and further cooled/dried before the hydrogen is directed to the storage tank. For the oxygen circuit, it can be the same from the cells to the storage tank, but the deoxidizer can be omitted and can only use cooler and dryer. On the oxygen line, there may also be a membrane adapted for the extraction of any hydrogen residues, which must be below 4% before the membrane and as low a hydrogen content as possible before the oxygen is stored in its tank. Compressors for the gases can be omitted if the entire system including the rotation device is adapted for an operating pressure equal to the storage pressure of the gases towards the end of the electrolysis. The system is ultra-compact and a reinforcement for higher pressure is therefore relatively simple and affordable, as is the use of nobler materials to reduce oxidation in the oxygen circuit from and including cells to the storage tank.

The water tanks at the top can be connected to their respective gases that can push the water back during water electrolysis. Each water tank can also be a combined gas and water tank with gas and water from the same side of membrane 4, in that they can contain a flexible dense membrane that separates gas and water. Thus, separate water tanks can be omitted. In this case, there must be a water pump on each water circuit, as the pressure is variable if there is little water and a lot of gas in the tank and vice versa. When the gases are led to the cells in fuel cell mode, they are connected/bypassed via valves in pipes around the compressor, deoxidizer and dryer respectively via their own gas pressure regulator, which controls the pressure in relation to the pressure of the water into the rotor and the rotational speed so that the water table is pushed outwards to outside the periphery of the cells as mentioned. You can also have a corresponding regulator or water pump on the water circuit that adjusts the water pressure from/to the rotor depending on whether the water pressure is too high or low in the tank in relation to the aforementioned water surface in the cell packets 54.

So far, the device is described with membrane, but the device can also use other known and new cell solutions adapted for cell packets in the rotation device, where it is beneficial to quickly remove the water from the cells during LT fuel cell mode and remove the production gases quickly by water electrolysis mode with the rotation device, as well as an improvement of temperature balance and equalization of temperature in the cells of high convection speed in the high G. This will improve contact between the electrodes, gases and water/steam.

At high pressure in the device, the supplied water can be saturated with its respective gasses, hydrogen and oxygen to each side of the cells during fuel cell mode. For example, the gas-saturated water can then enter the cells via their respective water collection channels 56, 57 and into the periphery of the cells, where the saturated gases react and produce electricity and water. The production water is mixed with the rest of the water and any released gases are directed into the cells of previous gas collection channels 31, 32 and further out into channels 2, 3. The same can be done in electrolyser mode and under high pressure and adapted heat, where the gases produced will be saturated in the water, which is degassed under lower pressure in the center of the rotor as mentioned or outside after the gland-box, or the water is cooled and stored with saturated gas. Higher water flow can be allowed to combine with cooling in both cell modes. When saturation of gas to/from cells, the cells should contain as diffusion-tight a membrane disc 4 as possible, which can be combined with the fact that the water is also an electrolyte and can be similar to the electrolyte in the membrane, for example alkaline water with up to 35% KOH (Potassium Hydroxide). Supplied production water in the electrolyte at the fuel cell mode is condensed/distilled out in the center or outside the device and the consumption of water during gas production is added in the right amount in the water circuit where it is consumed.

So far, said membrane disc 4 is explained as a solid electrolyte, but it can be replaced with a porous diaphragm of similar shape, which can be of the Zirfon type at LT, with or without reinforcement and a liquid electrolyte in contact with anode and cathode via the porous junction filling with the liquid electrolyte. Bipolar discs 5, 6 may be similar to those shown and described for FIG. 1 6A, B, but the radial shovels 17 may be porous with custom catalyst. The same can be done for the surface of bipolar discs 5, 6 facing the cell. The shovels 17 can be radially straight but axially drawn inward towards the cell and axially bent backwards in the direction of rotation inward towards its diaphragm in the active area and adapted backward bent shape so that they are elastic and with a good contact surface towards the diaphragm from each bipolar disc, which now becomes zero gap electrodes after the previous porous electrode discs 16 in contact with the previous membrane are removed in this case. The diaphragm must be constantly kept wet by an electrolyte, both for conductivity, but also for sealing so that the gases from each side do not mix. The procedure under fuel cell mode is then that both a mixture of, for example, 35% KOH electrolyte is led together with each gas in its channels 2, 3, where an adapted amount of electrolyte is fed together with the gases or in dedicated channels from gland-box 68 to gas inlet in the center to either side of the junction in the cells, where the electrolyte meets the backward-bent vanes, and due to the moment of inertia during constant rotation, the electrolyte on its way outwards will be forced by the axially backward-bent vanes constantly towards the diaphragm. The diaphragm is in contact with the electrode of the bipolar disc via the diaphragm via the electrolyte. It is a wet, thin electrolyte film where each gas comes into contact with its electrode and in the space between the vanes and against the diaphragm is the gas that starts reaction with the production of water and EL. The production water and the added electrolyte are continuously hurled outwards into the cells and to their combined water and electrolyte collection channels 57, 56 at the periphery. When reversing the process to a water electrolyser, this procedure is as described earlier of filling the cells with the electrolyte from the periphery by adjusting the gas pressure out and supplying the DC and water consumed in its circuit. Production gas channels 2, 3 are rapidly directed inwards towards the center and out as mentioned earlier.

The rotary device can have different rpm, pressure and temperature in fuel cell mode and water electrolysis mode.

As described in FIG. 1, it is advantageous that the cell gas channels 12, 13 to/from the cells are also bent backwards in the direction of rotation and enter gas collection channels 2, 3 at the inner periphery. Similar to that shown for cell water channels 20, 21 to/from water collection channels 57, 56 and cell gas channels 12, 13 are mirrored by cell water channels 20, 21 if viewed over the bipolar disc's 6A or 6B active center. This provides easier supply and export at multiphase mediums in the axial gas collection channels 31, 32 to/from the cell when the device is laid horizontally and at adapted rpm and pressure to utilize 1 G from the environment, so that there is −1 G up and +1 G down inside the reclining rotor. For example, electrolyte and gas in gas collection channels 31, 32 can be adapted so that electrolyte or water enters cell gas channels 12, 13 during rotation and into their sides in the cells when they are down and the gases enter when the channels are between down and up on each round. This provides a favorable natural and fast shift/pump between liquid and gas pulsation into the cells to keep membrane or diaphragm disc 4 sufficiently moist/wet in fuel cell mode.

So far, the procedure is explained by the fact that pure oxygen is supplied in its channels 3, 13, 32, to the cells in fuel cell mode, but this can also be an oxygen-rich gas that can be air. The air is supplied in the same channels as oxygen channel 3 with an adapted pressure that causes the air to bubble from cell water channel 21 (FIG. 1) out to water collection channel 57 and bubble on to outlet in its channels 24 together with the produced water. Water collection channels 57 and discharge channels must be in an adapted cross-sectional area that allows the gas to pass through the water so that the water surface 22 is kept constant at the inner periphery of the water collection channels 57. This can also apply to pure hydrogen and oxygen that can come out into their water collection channels with water or water vapor and be collected outside the rotor. By the conversion of most of the oxygen from the air in the cells, almost pure nitrogen comes out, which can be used for various purposes that can be for ammonia production and which can be with the Haber-Bosch method with hydrogen produced by the device. In fuel cell mode, Ammonia can also replace hydrogen or be used with it. Then pure nitrogen will also come out from the oxygen channel 24 and again be used as mentioned. Ammonia provides an alternative handling of the produced hydrogen.

The rotary device is so far described in several parts that are assembled with fasteners, sealants and insulators. But entire rotors or parts of it can also be 3D printed and where the different parts with potentially different materials are built up layerwise axially to form a complete balanced tight rotor with channels, which are simultaneously interconnected and it can be heated and can be applied a voltage (V) to achieve the desired property of the different materials in their place in the rotor as mentioned.

Said catalyst can be in any form or in combination of: platinum, nickel, iridium, cobalt, iron, yttrium, zirconium, strontium, lanthanum, manganese or materials with similar properties.

All figures and descriptions of them are principled and do not show the real design of the device.

### OVERVIEW REFERRAL FIGURES

1 Axis of rotation
2 Hydrogen channel
3 Oxygen channel
4 Membrane disc
5 Bipolar end discs
6 Center bipolar disc
7 Water droplets
8 Water collection channel
9 Outlet/inlet water
10 Inner insulation discs
11 Outer insulation discs
12 Cell gas channel for hydrogen
13 Cell gas channel for oxygen
14 The oxygen distribution channel
15 The hydrogen distribution channel
16 Electrode disc
17 Shovels, with grooves between them
18 Outer circular channel hydrogen water
19 Outer circular channel oxygen water
20 Cell water channel hydrogen
21 Cell water channel oxygen
22 Water surface in water collection channel 8
23 Water channel in/out from/to hydrogen side
24 Water channel in/out from/to the oxygen side
25 Stator end cap fluid side
26 Dynamic seals in gland-box 68
27 Shaft pipe channels 29
28 Fluid pipes
29 Shaft at fluid side
30 Seals and fasteners
31 Hydrogen collection channel
32 Oxygen collection channel
33 +Bipolar disc
34 +Insulation +bipolar disc 33 and +bolt 35
35 +Bolt
36 Shaft at EL side
37 Dynamic sealing at bearing 38
38 Bearing EL side
39 Slip Ring Ground
40 +/− Brushes
41 +Slip ring
42 EL motor insulator
43 EL Motor
44 Bolts with distance sleeves
45 Stator end cap EL side
46 EL insulating brush washer for +brushes
47 Stator disc
48 End cap
49 Locking nut EL side for end cap
50 Air inlet EL side
51 Air outlet EL side
52 Protective stator tube
53 Nozzle for temperature control
54 Cell pack
55 Nozzle for temperature control
56 Water collection channel from Hydrogen side
57 Water collection channel from Oxygen side
58 EL insulating and sealing hollow cylinder
59 Support cylinder
60 Drainage
61 Air inlet fluid side
62 Air outlet fluid side
63 Locking nut fluid side for end cap fluid side 64
64 End cap fluid side
65 Stator disc fluid side
66 Dynamic sealing fluid side
67 Bearing fluid side
68 Gland-box

1. Device for producing DC electricity and water with supplied hydrogen and oxygen, as well as where the device is arranged to be reversed to produce hydrogen and oxygen by supply of water and DC current,
where the device includes,
at least one bipolar cell pack aligned with several cells each with its electrolytic membrane in contact on each side with catalytic electrodes in contact with each bipolar disc and current insulating sealing discs,
an inlet for hydrogen leading to hydrogen channels to one side electrodes in the cell pack,
an inlet/outlet for oxygen leading to oxygen channels to the other side electrodes in the cell pack,
where the device either is arranged to either produce DC current that is conducted through the cell pack via at least one positive bipolar disc and via at least one negative bipolar disc, or produce hydrogen and oxygen in the cells by supply of water and DC current,
in that at least one bipolar cell pack is designed as a hollow cylinder, and the device further includes a rotational device aimed at rotating the cell pack,
brushes that put the electrodes in contact with a joined circuit,
as water is produced in the cells and ejected from the cells and conducted via channels to outlet via a gland-box.

2. Device according to claim 1 adapted to high pressure, each comprising its positive and negative brushes connected to DC current to/from the cell packets via an outer circuit,
with a positive brush being in contact with an EL conductive bolt in contact with a positive bipolar disc in contact with a cell pack on each side, where the cell packets of their other ends are further in contact with a common negative ground potential.

3. Device according to claim 1, further comprising an EL insulating protection tube with EL insulating end cap, supported by sealing stator discs, where air is directed to and from each end by the protective tube, a number of nozzles for temperature control with a temperature control fluid directed at the periphery of the support cylinder to balance temperature in the cell packets, as the temperature control fluid is directed to at least one outlet.

4. Device according to claim 1, where the said water is in the form of water vapor and the device is adapted to high pressure and temperature.

5. Device according to claim 1, where the aforementioned bipolar discs form electrodes with radial shovels that are axially bent backwards in the direction of rotation, since the surface of the bipolar discs towards the cells is porous and in contact with a membrane and a liquid electrolyte.

6. Device according to claim 1, where said membrane disc is a diaphragm disc that is kept wet with a liquid electrolyte with the help of each cell's bipolar disc, which is equipped with axially backward-bent vanes in the direction of rotation and forms electrodes that are in contact with either side of the membrane.

7. Device according to claim 1, where the said channels to/from the cells are radial and backward bent in the direction of rotation, where the gas channels enter the inner periphery of associated axial collection channels and the water/steam channels enter the outer periphery of associated axial collection channels.

8. Device according to claim 1, where said membrane and/or electrodes are catalytically coated and/or contain catalysts adapted for use in liquid water that may be electrolytic, or for use in water vapor phase and respectively adapted for low or high temperature.

9. Device according to claim 1, where said membrane is H+ proton conductive or OH− anionic conductive and includes a liquid electrolyte and/or polymer or ceramic material.

10. Device according to claim 1, where the room in the center within at least one cell pack is arranged to contain two gas separators, one for hydrogen and one for oxygen, where the gases are directed in the center and in/out from each separator, and the water is directed outwards in channels to each collection channel on the periphery.
